(19) United States
(12) Patent Application Publication
(10) Pub. No.: US 2005/0171915 A1
(43) Pub. Date: Aug. 4, 2005

(54) Postal franking meter used as a trusted gateway

(76) Inventors: Daniel Fearnley, Stratford, CT (US); Mark Ferraro, Hamden, CT (US)

Correspondence Address: PERMAN & GREEN, 425 POST ROAD, FAIRFIELD, CT, 06824, US

(21) Appl. No.: 10/768,556

(22) Filed: Jan. 30, 2004

(51) Int. Cl. H04L 9/00

(52) U.S. Cl. 705/60

(57) ABSTRACT

A trusted gateway system for a proof-of-postage system. The system includes a postage meter system, a secure accounting and financial system for providing secure information to the meter, a secure connection between the meter and accounting and financial system providing at least authentication and encryption between the meter and the financial system and accounting, and a user interface, remotely coupled to the meter and adapted to allow a user to access the meter functionality with respect to the accounting and financial system.

### CROSS-REFERENCE TO RELATED APPLICATIONS

### BACKGROUND OF THE INVENTION

1. Field of the Invention

The present invention relates to postage meter system and, more particularly to expanding the functionality of a metering system using a personal digital assistant device.

2. Brief Description of Related Developments

Postage meters and metering systems can take a variety of forms. A stand-alone system generally comprises a postage meter or franking machine that is adapted to produce postal or value-added indicia, that is self contained. Postage meters and franking systems are generally known in the art.

In addition to the stand-alone type system as described above there are mailing systems that are formed of a mailing machine (i.e. a machine that can perform different mailing related functions (e.g. feeding, stacking, separating, sealing of envelopes, etc.)) on which a postage meter is securely mounted. The postage meter is typically located in a securely sealed housing, which contains the accounting and printing mechanisms. In the past few years both ink jet printing technology and smart card technology (i.e. smart cards used for securely housing the accounting circuitry of the postage meter) have been employed in these postage meters. The mailing machine systems including an electronic postage meter have enabled the users of such equipment to customize the exact type of mailing system they require by designing the overall mailing system in a modular fashion. One is able to set up a mailing system that will include individually removable mounted modules that can be added to or removed from the mailing system. For example, if one had a modular mailing system without an envelope stacker, one could add such a module to their system, and thereby have a mailing system that is able to stack envelopes once the postage has been placed on envelopes that are fed into the system. If the stacker module requires repair, the stacker could easily be removed for repair since it is but one module within a modular system. Features such as inserters, feeders/separators, sealers, scales, moisteners, addressers, stackers, etc. can be added for use with a postage meter to form different types of mailing systems.

The meter infrastructure can comprise the support, accounting, and data security systems needed to provide the functionality of the metering device. Examples of postage metering systems and related systems are illustrated in U.S. Pat. Nos. 6,341,274, 6,009,417 and U.S. patent application Ser. No. 10/081,278, the disclosures of which are incorporated herein by reference in their entireties.

The metering device can include a postal security device (“PSD”) adapted to create digitally signed indicia. The postal security device generally comprises a physical hardware device. Alternatively, the postal security device can comprise a virtual device that can include for example, an Internet service provider application or server adapted to provide physical postal security device functionality. The PSD is generally in a physical secure housing and can include cryptographically secure funds and associated accounting registers. The PSD is generally utilized in a dynamic system that provides for the interchange of data between a funds provider source, a computational funds tracking and maintenance source and a printing source. Whether an Open System (OS) or a Closed System (CS), the PSD provides all security against fraudulent attacks against the system. The PSD provides customers with a number of alternative approaches to optimize the customer's use, tracking and replenishing of the customer's franking funds within the environment surrounding the dispensing of funds for proof or payment. A closed system approach generally provides a printing device within the franking device or within a cryptographically secure boundary as executed by a vendor or merchant. The franking device is generally dedicated to the imprinting of proof of payment and will take any desired form. Crediting new funds to the PSD can be managed by an interface, such as for example, a modem adapted to the franking device, which communicates cryptographically with a host data center, which provides funds for the PSD through the franking device. The communications between the franking device and the data center, or between the franking device and PSD, are cryptographically encoded with all transactions being verified by the cryptocode structure and certificate authorization schema as desired or required. The PSD can be moved from one franking device to another so long as each franking device is authorized or keyed to function with the PSD. The PSD has the ability to account for funds and history as related to the franking device to which it has been attached. The communications channel 91 between the franking device and the data center can be any type of desired communications channel. The PSD can also include an accounting register indicative of funds value and contains cryptographic means adapted for secure communications with a remote host for adjustment of the contents of the accounting register. The cryptographic means can generate data to be included in the indicia and disposed to account within the accounting register for funds value provided in the indicia and fail to generate that data when the accounting register satisfies a predetermined condition. Generally, the accounting register is a descending register and indicia are printed only if the value stored in the descending register is greater than the amount of postage value desired to be printed.

In postal and postage meter applications and systems, the interface or communication pathway between a postage meter and the infrastructure, such as the accounting system, the postal authority or a postal security device, is “secure” as that term is understood. For example, the communication pathway can be considered a secure channel that provides privacy, integrity, authentication and encryption between the meter and the infrastructure. This could also be referred to as a “trusted gateway” or “trust relationship” where the link between two domains, here for example a postal metering device and the meter infrastructure allows secure access and exchange.

### SUMMARY OF THE INVENTION

The present invention is directed to a trusted gateway system for a proof-of-postage system. In one embodiment the system comprises a postage meter system, a secure accounting and financial system for providing secure information to the meter, a secure connection between the meter and accounting and financial system providing at least authentication and encryption between the meter and the financial system and accounting, and a user interface, remotely coupled to the meter and adapted to allow a user to access the meter functionality with respect to the accounting and financial system.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is a block diagram of an architecture that can be used to practice the present invention.

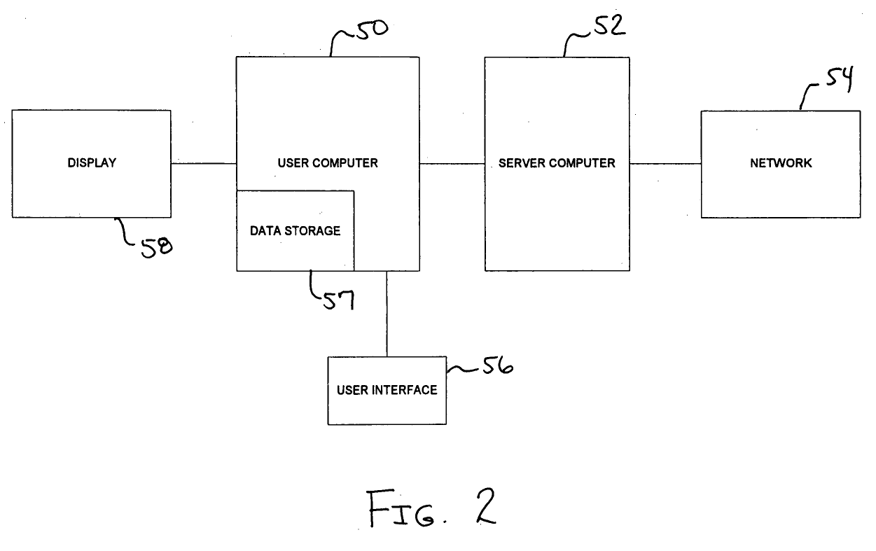

### DETAILED DESCRIPTION OF THE PREFERRED EMBODIMENT(s)

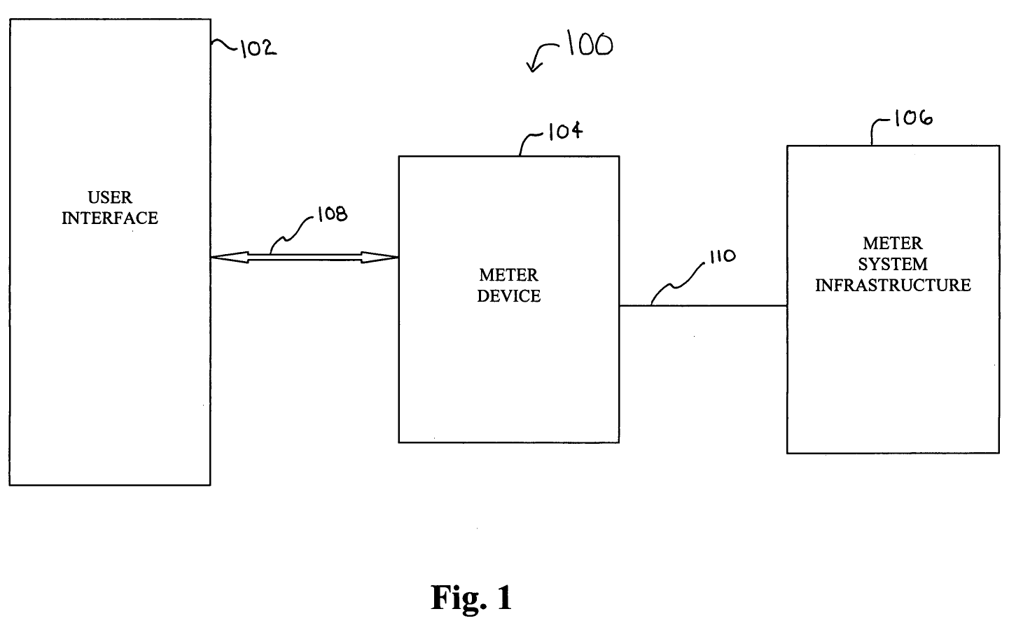

Referring to FIG. 1, a perspective view of a system 100 incorporating features of the present invention is illustrated. A postage metering system 100 generally comprises a meter device 104 and the meter system infrastructure 106. Value metering devices are devices that in their most basic form meter value. These devices take various forms such as, for example, postage meters (i.e. franking machines), various kinds of vending machines (i.e. lottery vending machines), tax stamp machines, various kinds of ticket dispensing machines, etc. Of these various devices, postage meters are one form of a value metering device that dispense value in the form of postage, e.g. postage indicia, basically either as a stand-alone type postage meter or as part of a mailing system. The stand-alone type postage meter is basically a postage meter having both its entire accounting system and security system positioned in a single secure housing, the accounting system being mechanically coupled to the printing mechanism which prints the postage related indicia.

The present invention generally comprises a “trusted gateway” of the communications network or pathway between the meter and the meter infrastructure by interfacing a machine man interface (“MMI”) with the meter. One example of a MMI is a PDA. The MMI takes advantage of the secure communications between the meter and/or meter infrastructure and the gateway leverages the functionality of the meter using external user interface devices. The trusted gateway allows access to the meter and the infrastructure, while preserving the trust relationship, security and authentication between the meter 104 and meter infrastructure 106. One example of a proof-of-postage generating system that includes a communication network or pathway between a meter 104 and a meter infrastructure 106 is illustrated in U.S. Pat. No. 6,009,417, the disclosure of which is incorporated herein by reference in its entirety.

In one embodiment, as shown in FIG. 1 a user interface 102 is coupled to the meter 104 to allow the user to communicate with the meter 104 and access all of the functionality of the meter 104 and meter infrastructure 106 through the user interface 102. The user interface 102 generally comprises any suitable device or control interface that allows a user to couple to the meter device, and interact with and/or control the operations and functionality of the meter device. The connection 100 between the interface 102 and the meter 104 as illustrated in FIG. 1, could be a direct, hard-wire connection, a wireless connection, or an optical connection link, for example. Generally, any suitable connection means between the meter 104 and user interface 102 can be used.

For example, in one embodiment, the user interface utilizes Bluetooth wireless technology to connect to, and access the meter 104. The user interface 102 can be adapted to display some or all of the meter functions, or input/output. The user interface 102 can be adapted to act as an extension of the meter 104 and enable the user to access and control the functions of the meter 104 through the user interface 102. In one embodiment, the meter may provide limited user access to its functions or have limited display functionality that are enhanced or made accessible by the user interface 102. For example, the meter 104 could be configured without a display or control panel, on with a limited function control panel. The user interface 102 could be configured to function as a complete or comprehensive display unit or control panel (graphical user interface (“GUI”)) for the meter 104. Since the meter 104 can be considered a “trust client” due to its secure or protected relationship with the meter infrastructure, the user interface 102 is a trusted gateway. Data can be passed to the meter 104 from the user interface 102 and from the meter 104 to the user interface 102 without concern regarding security and authentication between the meter 104 and the meter infrastructure 106. The connection 110 between the meter 104 and the meter infrastructure is generally a secure and encrypted connection, and can include a hardwire or wireless connection.

In one embodiment the user interface 102 can comprise for example, a personal digital assistant, also referred to as a PDA. The PDA acts as the interface to the meter 104, the trusted client, and takes advantage of the authentication and encryption between the meter and the infrastructure. The PDA can link to the meter 104 using any suitable wireless technology, including optical. The PDA could also be linked via a connection, to for example, a serial port on the meter. The PDA might also link to the meter via an online connection, such as for example the Internet. The display of the user interface, or PDA, could be adapted to mirror that of the postage meter. In those situations where the meter has only a limited display, additional functionality could be displayed on the meter. In this way, the present invention can expand the functionality of the meter using the interface or graphical user device (“GUI”).

Other devices could also be used as the interface 102, including for example, a wireless telephone, a computer or laptop, or other user GUI. In one embodiment, voice activated interfaces could be used. A browser functionality on the user interface 102 can be utilized to access the functionality of the meter 104.

Although the invention is described in terms of a postage system, it can be applied to other systems requiring a gateway to a secure channel.

The present invention may also include software and computer programs incorporating the process steps and instructions described above that are executed in different computers. In the preferred embodiment, the computers are connected to the Internet. FIG. 5 is a block diagram of one embodiment of a typical apparatus incorporating features of the present invention that may be used to practice the present invention. As shown, a computer system 50 may be linked to another computer system 52, such that the computers 50 and 52 are capable of sending information to each other and receiving information from each other. In one embodiment, computer system 52 could include a server computer adapted to communicate with a network 54, such as for example, the Internet. Computer systems 50 and 52 can be linked together in any conventional manner including a modem, hard wire connection, or fiber optic link. Generally, information can be made available to both computer systems 50 and 52 using a communication protocol typically sent over a communication channel or through a dial-up connection on ISDN line. Computers 50 and 52 are generally adapted to utilize program storage devices embodying machine readable program source code which is adapted to cause the computers 50 and 52 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 50 and 52 may also include a microprocessor for executing stored programs. Computer 50 may include a data storage device 56 on its program storage device for the storage of information and data. The computer program or software incorporating the processes and method steps incorporating features of the present invention may be stored in one or more computers 50 and 52 on an otherwise conventional program storage device. In one embodiment, computers 50 and 52 may include a user interface 57, and a display interface 58 from which features of the present invention can be accessed. The user interface 57 and the display interface 58 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A trusted gateway system for a proof-of-postage system comprising:.
a postage meter system;
a secure accounting and financial system for providing secure information to the meter;
a secure connection between the meter and accounting and financial system providing at least authentication and encryption between the meter and the financial system and accounting; and
a user interface, remotely coupled to the meter and adapted to allow a user to access the meter functionality with respect to the accounting and financial system.

2. The system of claim 1 wherein the user interface communicates with the meter over a wireless communication pathway.

3. The system of claim 1 wherein the user interface comprises a personal digital assistant.

4. The system of claim 1 wherein the user interface is securely isolated from the secure connection between the meter and the accounting and financial system.
